(19) United States
(12) Patent Application Publication
(10) Pub. No.: US 2006/0198123 A1
(43) Pub. Date: Sep. 7, 2006

(54) AUTOMOTIVE VISOR WITH ILLUMINATED MIRROR ASSEMBLY

(76) Inventor: Bodgan Radu, Dearborn, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/906,667

(22) Filed: Mar. 1, 2005

(51) Int. Cl. F21V 33/00

(52) U.S. Cl. 362/135; 362/602; 362/615

(57) ABSTRACT

An illuminated mirror assembly for an automotive visor includes a mirror and a light-transmitting prism. The prism has a first portion exposed to a light source and a second portion positioned adjacent a reflective surface of the mirror. Light from the source is transmitted through the prism to illuminate objects positioned in front of the reflective surface. In one embodiment, the prism and a housing are integrally formed around the mirror in a two-shot molding operation.

### CROSS REFERENCE

The present invention is related to U.S. Ser. No. 10/708,312, filed Feb. 24, 2004, U.S. Ser. No. 10/710,497, filed Jul. 15, 2004, U.S. Ser. No. 10/710,498, filed Jul. 15, 2004, U.S. Ser. No. 10/711,457, filed Sep. 20, 2004, U.S. Ser. No. 10/711,652, filed Sep. 29, 2004, and U.S. Ser. No. 10/711,480, filed Sep. 21, 2004.

### FIELD OF THE INVENTION

The present invention relates generally to visors for automobiles, and more particularly to a visor having an illuminated mirror assembly.

### BACKGROUND OF THE INVENTION

Visors have been provided in automobiles to shield occupants' eyes from glaring sunlight which enters the vehicle interior through the windshield or through the side windows. Conventional automotive visors are moveable from a stowed position adjacent the roof or headliner of the automobile, to a downwardly extending position adjacent the windshield to help block the sunlight, as may be desired. Conventional visors are also pivotable from the position adjacent the windshield to a position adjacent the side window, as known in the art. Many automotive visors also include vanity mirrors that permit vehicle occupants to view themselves.

In nighttime or low light conditions, it is often desirable to provide illumination associated with the vanity mirror to facilitate viewing during such conditions. Heretofore, illuminated vanity mirrors for automotive visors typically comprised multiple, individual components that must be assembled together and integrated into the visor. The multiple individual components of these prior vanity mirror contribute to the time and expense required to produce the visors. A need therefore exists for an illuminated mirror assembly for automotive visors that overcomes these and other drawbacks of the prior art.

### SUMMARY OF THE INVENTION

The present invention provides an illuminated mirror assembly for use with automotive visors that greatly reduces the time and effort to fabricate the mirror assembly. In one embodiment, the mirror assembly includes a mirror having a reflective surface, and a light transmitting prism having a first portion exposed to a light source and a second portion disposed adjacent the reflective surface of the mirror. Light is transmitted from the light source, through the first portion of the prism, to the second portion adjacent the reflective surface to provide illumination of objects in front of the reflective surface.

In another embodiment, the mirror assembly may further include a housing or bezel coupled to the mirror and supporting the mirror thereon. The housing and prism may be formed from polymeric materials and the mirror may be integrally molded with at least one of the housing and the prism. Because the light transmitting prism directs light from the light source to the reflective surface of the mirror, the light source may be placed at a location behind the reflective surface of the mirror, or at any other desired location. A mirror assembly according to the invention, eliminates the need for additional components such as reflectors or lens covers, and comprises an integrated assembly for incorporation into an automotive visor.

In another embodiment of the invention, a method of forming an illuminated mirror assembly includes locating a light transmitting prism adjacent a mirror, the prism having a first portion exposed to a light source and a second portion disposed adjacent a reflective surface of the mirror. The method may further include placing the mirror in a mold and molding the prism adjacent the mirror.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an automobile having an exemplary mirror assembly provided on a visor, according to the present invention;

FIG. 2 is an exploded perspective view of an automotive visor, including an exemplary mirror assembly according to the invention;

FIG. 3 is a perspective view of the mirror assembly of FIG. 2, viewed opposite the reflective surface of the mirror;

FIG. 4 is a cross-sectional view of the mirror assembly of FIG. 2, taken along line 4-4; and

FIG. 5 is an enlarged detail view of the cross-section of FIG. 4.

### DETAILED DESCRIPTION

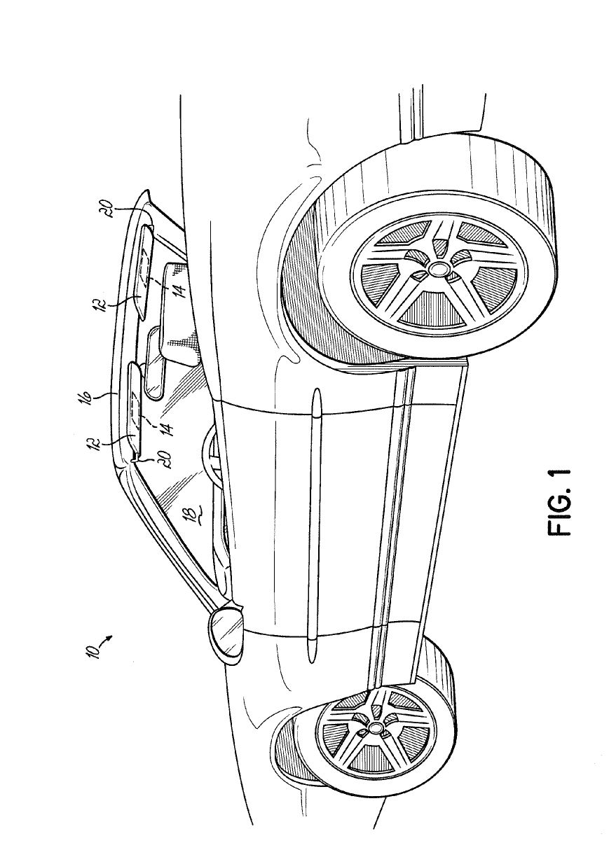

Referring to FIG. 1, an automobile 10 includes sun visors 12 with exemplary mirror assemblies 14 according to the present invention. The sun visors 12 are moveably secured to an upper portion of the vehicle body 16, adjacent the windshield 18. The visors 12 are moveable from a stowed position (depicted in FIG. 1) to a downwardly extending position adjacent windshield 18 by pivoting the visors 12 about a mounting arm 20, as known in the art. Mounting arm 20 also facilitates positioning the visors 12 away from the windshield 18 toward a position adjacent the side windows of the automobile 10, as known in the art.

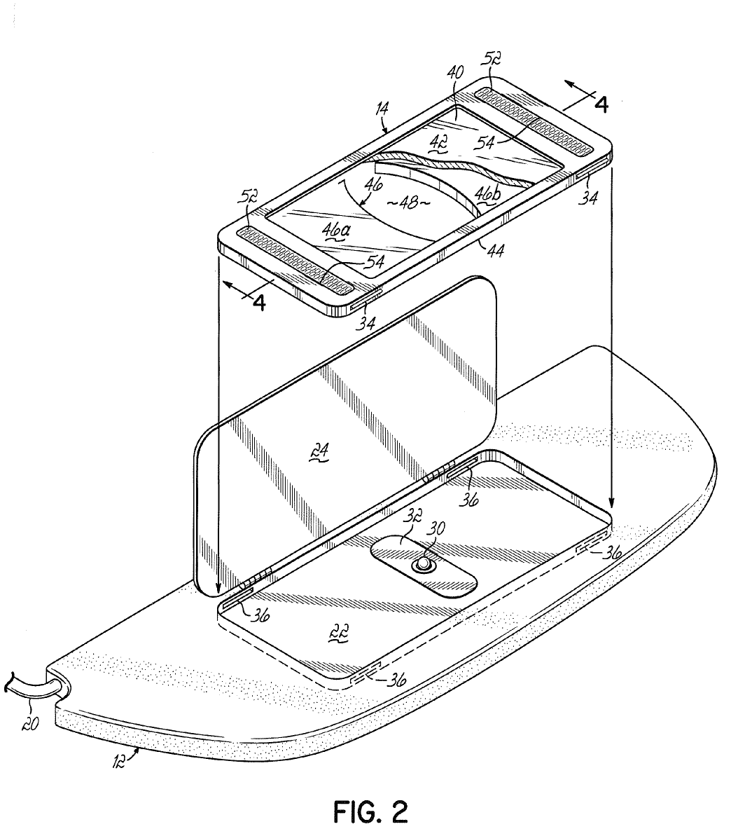

Referring now to FIG. 2, the visor 12 and mirror assembly 14 are shown in greater detail. In the embodiment shown, mirror assembly 14 is provided in a compartment 22 formed in the visor and is concealable by a cover 24 hingedly coupled to the visor 12. A light source 30, such as an incandescent bulb, a light-emitting diode, or any other suitable light source, is provided in the recess 22 and is secured by a cover 32, brackets or other structure, as known in the art. The mirror assembly 14 is sized to be received within the recess 22, and is secured, for example, by tabs 34 provided around the periphery of the mirror assembly 14 and arranged to engage corresponding slots 36 formed in the recess 22, whereby the mirror assembly 14 may be snap-fit within the recess 22, generally over the light source 30. It will be recognized by those skilled in the art that various other configurations for securing mirror assembly 114 and light source 30 to visor 12 are possible and that the visor 12 may or may not include a cover for concealing the mirror assembly 14 as shown and described herein.

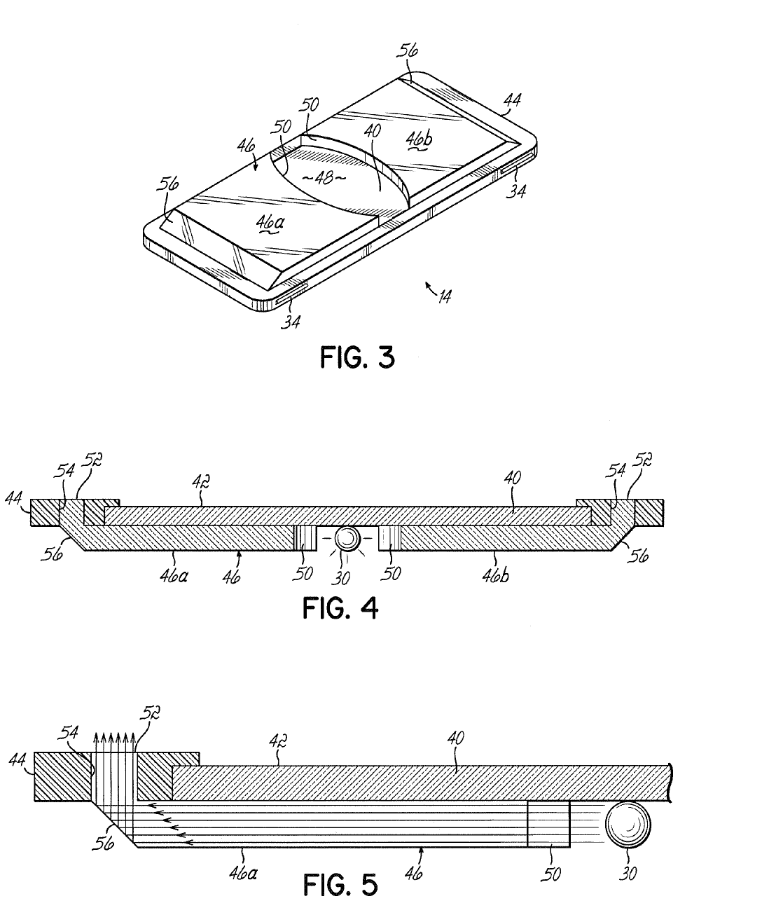

With continued reference to FIG. 2 and referring further to FIG. 3, the mirror assembly 14 includes a mirror 40 having a reflective surface 42. The mirror 40 is supported on a bezel or housing 44 which extends generally around the periphery of the mirror 40. The mirror assembly 14 further includes a light transmitting prism 46 disposed generally behind the reflective surface 42 of the mirror 40. In the embodiment shown, the prism 46 comprises first and second symmetrical halves 46a, 46b that are spaced apart to define an open area 48 therebetween. Each of the first and second halves 46a, 46b of the prism 46 includes a first portion 50, generally adjacent the open area 48, and a second portion 52, distal from the first portion 50 and positioned adjacent the reflective surface 42 of the mirror 40. Advantageously, the first and second portions 46a, 46b, of the prism 46 cooperate to transmit light that impinges the first portions 50, through the prism 46, to the second portions 52 to thereby illuminate objects positioned in front of the reflective surface 42 of the mirror 40. In the embodiment shown, the housing 44 includes a pair of elongate apertures 54 disposed on longitudinally opposite sides of the mirror 40. The second portions 52 of the prism 46 extend through the apertures 54 so that they are located adjacent the reflective surface 42 of the mirror 40.

With continued reference to FIGS. 2 and 3, and referring further to FIGS. 4 and 5, the open area 48 between the first and second halves 46a, 46b, of the prism 46 defines a space for positioning a light source 30 adjacent the first portions 50 of the first and second halves 46a, 46b of the prism 46. As depicted in FIG. 5, light emitted from the light source 30 enters the first portions 50 of the prism 46 and is transmitted through the prism 46 toward angled facets 56 spaced from the first portions 50. Light is reflected from the facets 56 toward the second portions 52, which extend through the apertures 54 formed in the housing 44, and outwardly of the mirror assembly 14 adjacent the reflective mirror surface 42 to thereby illuminate objects positioned in front of the reflective surface 42.

The housing 44 and prism 46 may be formed as individual components that are assembled together to form the mirror assembly 14 shown and described above. Alternatively, the mirror assembly 14 may be formed as an integral unit, whereby the mirror 40 is placed into a mold and one or more of the prism 46 and housing 44 is integrally molded to the mirror 40. In one embodiment, the housing 44 is molded to the mirror 40 in

What is claimed is:

1. An illuminated mirror assembly, comprising:
a mirror having a reflective surface; and
a light transmitting prism proximate said mirror, said prism having a first portion adapted to be exposed to a light source and a second portion disposed adjacent said reflective surface of said mirror, said second portion cooperating with said first portion to transmit light from the light source, through said prism, to a location adjacent said reflective surface.

2. The mirror assembly of claim 1, further comprising:
a housing coupled to said mirror and supporting said mirror thereon.

3. The mirror assembly of claim 2, wherein said housing and prism are formed from polymeric materials, and wherein said mirror is integrally molded to at least one of said housing and said prism.

4. The mirror assembly of claim 2, further comprising:
an aperture formed through said housing, adjacent said mirror;
said second portion of said prism extending though said aperture to thereby transmit light from the source to a location adjacent said reflective surface of said mirror.

5. The mirror assembly of claim 1, wherein said mirror is supported directly by said prism.

6. The mirror assembly of claim 5, wherein at least part of said prism is opaque.

7. The mirror assembly of claim 6, wherein said prism is formed from co-injected first and second polymeric materials, said first material having light transmitting characteristics and said second material being opaque.

8. The mirror assembly of claim 1 further comprising said light source disposed proximate said first portion of said prism.

9. The mirror assembly of claim 8, wherein said light source is located directly behind said mirror, opposite said reflective surface.

10. An automotive sun visor, comprising:
a visor body;
an illuminated mirror assembly coupled to said visor body, said mirror assembly comprising:
a mirror having a reflective surface, and
a light transmitting prism proximate said mirror, said prism having a first portion and a second portion, said second portion disposed adjacent said reflective surface of said mirror; and
a light source disposed proximate said first portion of said prism;
said second portion of said prism cooperating with said first portion to transmit light from said light source, through said prism, to a location adjacent said reflective surface.

11. The visor of claim 10, further comprising:
a housing coupled to said mirror and supporting said mirror thereon.

12. A method of forming an illuminated mirror assembly, comprising:
affixing a light transmitting prism adjacent a mirror, with a first portion of the prism positioned behind a reflective surface of the mirror and a second portion disposed adjacent the reflective surface of the mirror; and
affixing a light source proximate the first portion of the prism.

13. The method of claim 12, wherein locating the light transmitting prism adjacent the mirror comprises:
placing the mirror in a mold; and
molding the prism adjacent the mirror.

14. The method of claim 13, further comprising:
molding a housing adjacent the mirror and prism.

15. The method of claim 14, wherein the housing and the prism are formed from the same material.

16. The method of claim 14, wherein molding the prism and molding the housing comprise:
molding one of the housing and prism during a first shot of a two-shot molding process; and
molding the other of the housing and prism during a second shot of the two-shot molding process.
